(19) United States
(12) Patent Application Publication
(10) Pub. No.: US 2005/0289653 A1
(43) Pub. Date: Dec. 29, 2005

(54) System and method of trusted publishing

(76) Inventors: Dale Darling, Toronto (CA); Prasad Maruvada, Newmarket (CA); John Wylie, Toronto (CA)

Correspondence Address: STEUBING AND MCGUINESS & MANARAS LLP, 125 NAGOG PARK, ACTON, MA, 01720, US

(21) Appl. No.: 11/077,706

(22) Filed: Mar. 10, 2005

(30) Foreign Application Priority Data
Mar. 10, 2004 (CA) 2460467

(51) Int. Cl. G06F 17/30

(52) U.S. Cl. 726/26

(57) ABSTRACT

A trusted publishing system for publishing trusted content is provided. The system comprises a publisher trust envelope module for converting content into a trusted document, and a consumer trust envelope module for validating the trusted document.

### FIELD OF THE INVENTION

The invention relates generally to electronic document publishing and in particular to a system and method of trusted publishing.

### BACKGROUND

A content publisher may be any entity that produces content of any sort, including document files, images, songs, movies, sounds, or other media files, streaming content, applications, services, plug-ins or any other type of data or program that can be presented to and used by the consumer in any fashion. In this specification, the terms “content” and “product” are used to refer to any of these types of content.

Spam and viruses spread at an alarming rate, and there is no technical mechanism to guarantee that legitimate business can communicate with willing customers while still protecting users from the glut of spam Consumers have no guaranteed means by which to ensure that any arbitrary content they view comes from a trusted source, nor to limit or control content viewed on their system based on the publisher. Nor can consumers strictly control the type of content that can be opened on their computer. Further, consumers have and no way of dealing with publishers who spam or send offensive content.

Governments and institutions have no means by which to track and therefore enforce laws or restrictions on content publishers.

Content publishers have no guaranteed means to prevent illicit companies from spoofing their branding in arbitrary document or media types. Further, content publishers have no way to protect their arbitrary content after it has been released, with no mechanism to prevent viral spreading of that content, and no way to benefit from that content once it has reached the public domain.

Also, content publishers have no way to control or limit consumer usage of their content, especially where it concerns content that is passive—with no inherent executing code to implement copy protection mechanisms. Moreover, disparate purchasing mechanisms limit the ability of content publishers to charge for their content, and make it difficult for users to purchase goods from various sources.

The cost of implementing purchasing infrastructures often prevents content publishers from adopting purchasing technologies. Further, content publishers have no convenient means of communicating with consumers of their content, and therefore no mechanism to provide offers for new content or upgrades of existing content.

### SUMMARY OF THE INVENTION

In accordance with an embodiment of the present invention, there is provided a trusted publishing system for publishing trusted content. The system comprises a publisher trust envelope module for converting content into a trusted document, and a consumer trust envelope module for validating the trusted document.

In accordance with another embodiment of the present invention, there is provided a method of publishing trusted content. The method comprises the steps of generating a trust envelope for content, placing an encrypted hash of the content in the trust envelope, placing the content in the trust envelope, and placing a publisher identifier in the trust envelope.

In accordance with another embodiment of the present invention, there is provided a method of viewing trusted content. The method comprises the steps of receiving a trust envelope, determining a publisher decryption key to decrypt the encrypted hash of the content into a decrypted hash, performing a local hash of the content and comparing the local hash with the decrypted hash, and allowing a viewer to view the content if the local hash and the decrypted hash match The trust envelope includes content, an encrypted hash of the content, and a publisher identifier.

### BRIEF DESCRIPTION OF THE DRAWINGS

FIG. 1 shows an example of a trusted publishing system, in accordance with an embodiment of the present invention.

FIG. 2 shows a more detailed example of the trusted publishing system, in accordance with an embodiment of the present invention.

FIG. 3 shows in a flowchart an example of a content publishing workflow, in accordance with an embodiment of the trusted publishing system.

FIG. 4 shows in a flowchart an example of a content viewing workflow, in accordance with an embodiment of the trusted publishing system.

FIG. 5 shows in a flowchart an example of a method of publishing trusted content via email, in accordance with an embodiment of the trusted publishing system FIG. 6 illustrates an example of a process of publishing and consuming trusted content, in accordance with an embodiment of the trusted publishing system

### DETAILED DESCRIPTION OF THE PREFERRED EMBODIMENTS

A system and method of the present patent disclosure will now be described with reference to various examples of how the embodiments can best be made and used. For convenience, like reference numerals are used throughout the description and several views of the drawings to indicate like or corresponding parts, wherein the various elements are not necessarily drawn to scale.

Trusted Publishing

A publisher is any entity that produces content using any means. A consumer is any entity that uses this content in any way. They may or may not be the same entity.

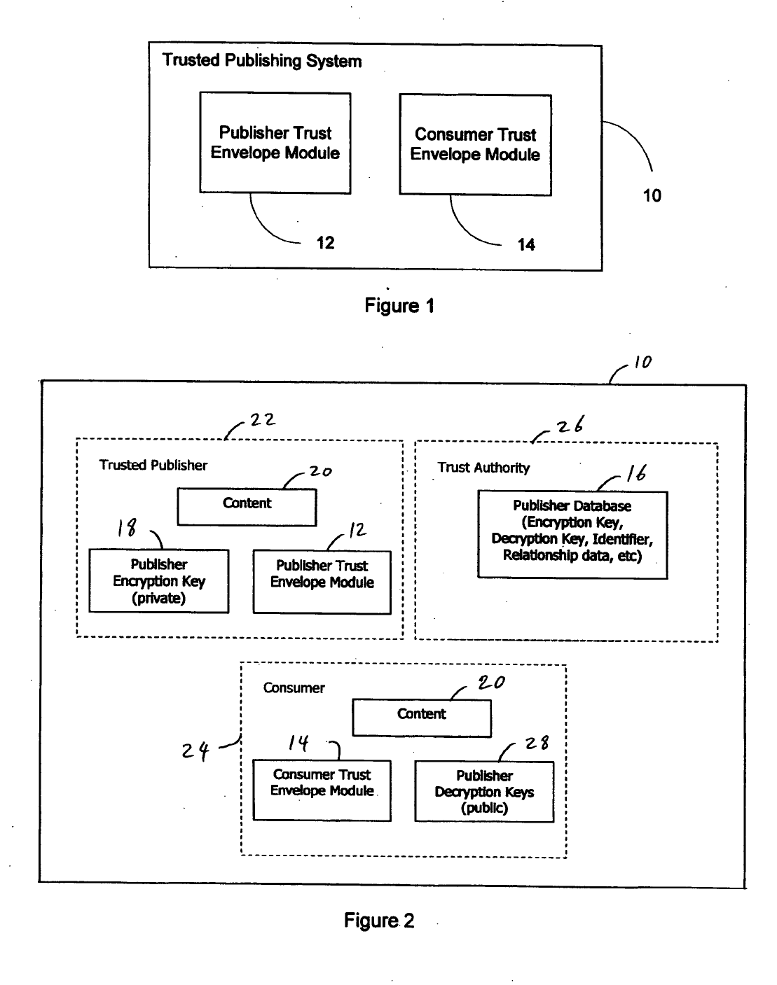

FIG. 1 shows an example of a trusted publishing system 10, in accordance with an embodiment of the present invention. The trusted publishing system 10 comprises a publisher trust envelope module 12 for converting content (such as a document) into a trusted document, and a consumer trust envelope module 14 for validating the trusted document.

FIG. 2 shows a more detailed example of the trusted publishing system 10, in accordance with an embodiment of the present invention. The trusted publishing system 10 includes a trusted publisher module 22 (or trusted publisher) using the publisher trust envelope module 12, and a consumer module 24 (or consumer) using the consumer trust envelope module 14. Preferably, the system 10 also includes a trust authority module 26 (or trust authority) that implements trust relationship modules described below. The trusted publisher module 22, consumer module 24, and trust authority module 26 may be implemented on computer servers. The consumer module 24 can also be run on desktop (client/end user) computers.

The trusted publisher module includes content 20 such as a document, a publisher encryption key 18, and the publisher trust envelope module 12. The consumer module 24 may view the document or content 20, and includes a publisher decryption key 28 (preferably, the consumer module 24 will have a list of publisher decryption keys, each tagged using the publisher identifier) and the consumer trust envelope module 14. The trust authority module 26 includes a publisher database 16 which holds data representing encryption and decryption keys, identifiers, relationship data, etc.

Publishing Trusted Content

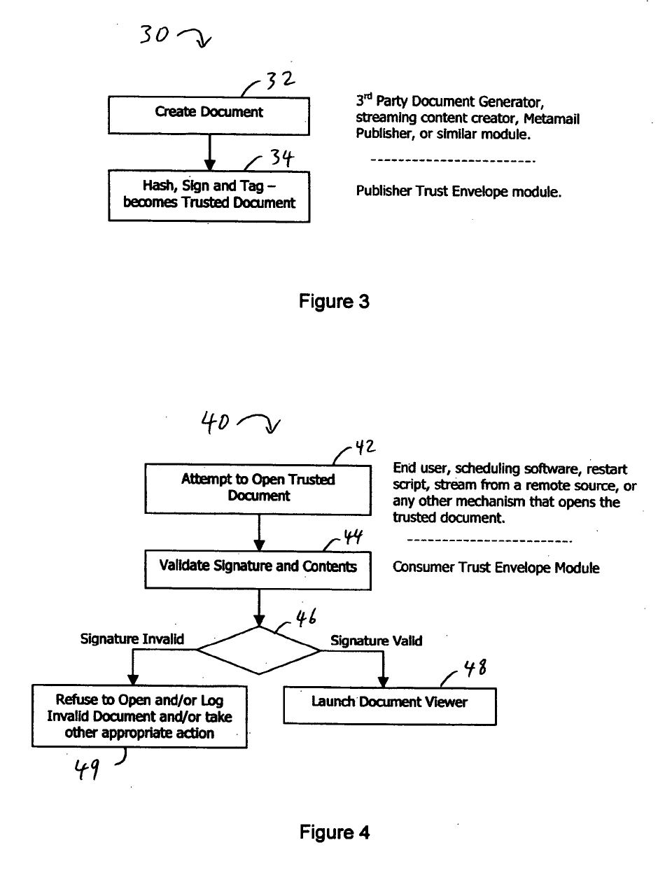

FIG. 3 shows in a flowchart an example of a document publishing workflow (30), in accordance with an embodiment of the trusted publishing system 10. A user creates a document (32) and then the document is protected using the publisher trust envelope module 12 to become a trusted document (34).

When publishing content, i.e., an application or any other form of content, the publisher may create content of any sort, using any tool applicable to generate that content. This includes such content as: document files (*.doc, *.xls, *.pdf, etc); xml files; media files such as movies (*.mpg, *.wmv, *.qt, etc), songs (*.mp3, etc), images (*.jpg, *.png, *.gif, etc), sounds (*.wav, etc) and other media types; streaming content; web sites; applications (*.exe, *.scr, etc); services; email message (MIME, HTML, Rich Text, Plain Text, or any other email format); or any other type of content that can be manipulated in any fashion on a computer. Content also includes any compound formats—which can include one or more instances of one or more of the content types described above. The publisher also uses the publisher trust envelope module 12 to generate a trust envelope around the content. Among other things, this trust envelope comprises a hash of the content and a publisher identifier (see the Trust Envelope section below). The hash is encrypted using a publisher encryption key—a private encryption key unique to that publisher, and industry standard encryption technology. A Trusted Publisher may apply for more than one Publisher Encryption Key, and each would have its own unique identifier. Other parts of the trust envelope and/or content may also be encrypted. Once the trust envelope is generated around the content, the content is considered to be trusted content.

Consuming Trusted Content

FIG. 4 shows in a flowchart an example of a document viewing workflow (40), in accordance with an embodiment of the trusted publishing system 10. First, a consumer or some process functioning on the consumer's behalf attempts to open the trusted content (42). The consumer trust envelope module 12 intercepts the request to open the trusted content and validates the trusted content (44). The validation step includes examining the publisher identifier in the trust envelope. Using this identifier, the appropriate publisher decryption key is extracted, either from a local cache, or from the trust authority module 26, as appropriate, to use to decrypt other portions of the trust envelope and/or the protected content. Using the decryption key, the consumer trust envelope module 12 then decrypts the hash in the trust envelope. The consumer trust envelope module 12 then runs the same hash algorithm performed by the publisher trust envelope module. If the hash calculated by the consumer trust envelope module 12 matches the hash in the trust envelope, then the signature is valid (46) and the consumer trust envelope module 12 may decrypt any encrypted content if desired, and open the content for viewing (48). The consumer trust envelope module 12 may perform other actions as well.

Preferably, if the hashes do not match (i.e., the signature is invalid (46)), the consumer trust envelope module 12 refuses to open the content (49), thus protecting the consumer and publisher from illicit content. Alternatively, the consumer trust envelope module 12 may perform other applicable tasks such as invalidating the document.

Publisher Trust Envelope Module 12

The publisher trust envelope module 12:
Performs a hash algorithm on the content;
Encrypts the resulting hash using the private Publisher Encryption Key;
Generates the trust envelope—which surrounds the content and holds the encrypted hash, the Publisher Identifier, and any other information that might be desirable to support the features of the system; and
Saves the resulting information with the trust envelope.
   The publisher trust envelope module 12 may also be responsible for packaging and supporting other trust envelope features, and may also provide extensibility in a modular fashion—allowing other modules and third parties to tap into the Trusted Publishing process (see the Trust Relationships section below).
   Consumer Trust Envelope Module 14

The consumer trust envelope module 14:
Determines the decryption key to use, based on the Publisher Identifier found in the trust envelope;
Preferably, it retrieves these decryption keys directly from a trust authority and cache them for use later, potentially revoking or updating keys as required;
Decrypts the hash;
Performs the hash algorithm on the content;
Compares the results of the hash with the hash decrypted from the trust envelope; and
Launches the appropriate viewer for the content when the hash has been validated.
   The consumer trust envelope module 14 may perform other operations based on additional content in the trust envelope or based on other features provided as described infra The consumer trust envelope module 14 may also provide extensibility in a modular fashion—allowing other modules and third parties to tap into the Trusted Publishing process (see the Trust Relationships section below).
   The Trust Envelope

The trust envelope comprises the following:
Publisher Identifier (not encrypted);
Hash of the content (encrypted using the private Publisher Encryption Key); and
The content itself (may or may not be encrypted and/or compressed). Preferably, the trust envelope further comprises:
Content type information (encrypted)—Used for screening and filtering. Preferably, this is encrypted to be sure that a malicious third party does not misrepresent the contents during transport;
Usage limitations (encrypted)—Used for use-based licensing agreements, trial-periods, subscription management, etc.;
Billing information (encrypted)—Used to aid in purchasing the use of trusted content, such as applications, songs, documents, movies, etc).; and
Transactional information (used to manage relationships between publishers and consumers, for such purposes as technical support, two-way marketing and interactions, product update requests, information requests, etc.
   Trusted Publisher Module 22

A trusted publisher module 22 may be implemented as application on a publisher's server that generates trusted content using the systems described herein.

Trust Authority Module 26

Preferably, the trusted publishing system 10 includes a trust authority module 26, which is an entity that used supporting systems to provide:
Trusted Publisher Licensing and management; and
Management and potentially distribution of Trusted Publisher data, including but not limited to: Publisher Identifier, Publisher Encryption Keys and Consumer Decryption Keys.
   It is preferable for the trust authority module 26 to have functionality to police the Trusted Publishers, such as key revocation and rights management. It is also preferable for the trust authority module 26 to manage the relationship between the Trusted Publisher and the Consumer to support the processes identified in the Trust Relationships section below.
   Trust Relationships

Preferably, the relationship between the consumer and the publisher is managed by a trust authority entity and supported by modules 26 used by the consumer and publisher. The trust authority module 26 may provide any of the process functions described below. A trust authority entity may or may not also be a consumer and/or publisher of trusted content. Preferably, the trust authority functionality is implemented in the trust authority module 26. Such functionality can include any of the following processes, which may also impact Trusted Publisher 22 and Consumer 24 modules and processes.

Content Claims, Screening, and Content Violation Reporting

Preferably, the trust envelope has tags that indicate the type of information presented in the content. The following process illustrates an example of a Trusted Publisher's Content claim, which is the publisher's assertion that the content fits one of the categories provided.
Before the Publisher Trust Envelope Module 12 completes the process of signing and hashing the content, it requests content tags which indicate the type of content included.
Content categories can be hierarchical or simply flat and include such things as: rating (family, parental guidance, restricted, etc), rating details (violence, foul language, blood, etc), subject category (entertainment, business, advertisement, etc), subject subcategory (movies, music, videos, television, books, etc), subject matter (movie A, video B, book C, etc), content type (image, video, music, application, etc), content subtype (nature image, car image, etc; game application, utility application, business application, content creation application, etc; etc).
Preferably, this list is not static, and content types can be added by the trust authority in the future, as desired. The Trust Authority (entity or module 26) can be responsible for dissemination of new content types to Trusted Publishers and Consumers.
These content claim tags are included in the trust envelope, within the encrypted section.
The encrypted section of the trust envelope is included in the hash along with the content itself.

The following process in an example of an indication of how the end user can use the content claim and the publisher identifier to implement filtering of any type of content protected by the Trusted Publishing system.
Preferably, the Consumer Trust Envelope Module 14 provides a mechanism for the user to specify the types of content to detect, and what action to perform when the content of the specified type(s) is detected. These actions can include automatic deletion of the content, refusal to open the content, visual warning of the content, reporting the content to the trust authority, or other actions.
This could also include the ability to flag content of any time that is received from a specific publisher or classification of publishers to be screened.
Publisher Classification is similar to content classification, and simply indicates the type of content most regularly sent by this publisher, or this publisher using the specific Publisher Identifier.
When the consumer attempts to open the trusted content, the Consumer Trust Envelope Module 14 intercepts the attempt.
After validating the source and the hash of the content and the trust header encryption section, the Consumer Trust Envelope Module 14 then compares the content types verses the users preferences.
If the content type matches one specified by the user, then the action specified by the user is performed. Other actions might be taken automatically by the Consumer Trust Envelope Module 14.

Content claim violations occur when a Trusted Publisher fails to accurately specify the type of content found within the trusted content. Exact rules describing the meaning of each type of content can be made available by the trust authority (entity or module 26) so consumers can determine if the content indeed breaks the trusted content rules. Preferably, these rules are not static, and are made freely and conveniently available by the trust authority to both consumers and trusted publishers.

Preferably, the Consumer Trust Envelope Module 12 includes a mechanism by which the consumer can report a potential content claim violation, and track that violation afterwards. The Trust Authority can then investigate the claim, and deal with the Trusted Publisher, or the authorities, as appropriate, as per the severity of the claim The Trust Authority might also revoke the publishing rights for that Trusted Publisher, at it's sole discretion

Preferably, the Trust Authority would be responsible for distributing Publisher Decryption Key revocation notifications to the Trusted Publisher and all Consumers. Preferably, this is handled automatically by the Trust Authority module 26 and the Consumer Trust Envelope Module 12.

Purchasing Extensions

Preferably, the Consumer Trust Envelope Module 12 provides a single purchasing mechanism for the consumer for all types of content that can be protected by the trust envelope.

Preferably, the purchase is managed by the Trust Authority and order fulfillment is negotiated with the Trusted Publishers systems or by systems provided by the Trust Authority as applicable, in an automated fashion in the trust authority module 26.

Preferably, the consumer would only have to enter their purchasing credentials once to the Trust Authority module 26, and could make all future purchases through the Trusted Publishing system 10 without re-entering their purchasing details.

Usage Rights Management

Preferably, mechanism would be made available in the Trusted Publisher system 10 which would allow Trusted Publishers to define usage rights for any content 20 they publish

Usage rights may include (among other concepts): time-limited use (for instance, one month trials, etc); use-count limitations (for instance, ten uses of the content, etc.); subscription restrictions (similar to time or use-count rights, but connected to the Purchasing Extensions for subscription renewals and other options, etc.); and may or may not be specifically limited to a single user or single group of users; etc.

Preferably, the Publisher Trust Envelope Module 12 allows the Trust Publisher to encrypt the usage rights into the trust envelope, and the Consumer Trust Envelope Module 12 implements all required features to restrict usage according to those rules. The Consumer Trust Envelope Module 12 may also communicate with the Trust Authority when managing the rights management, for instance, for upgrading or renewing subscriptions. Preferably, the Trust Authority would negotiate such transactions with the Trusted Publisher in an automated fashion, similar to the mechanisms defined in the Purchasing Extensions section.

Consumer Identity

Preferably, the Consumer Trust Envelope Module 12 uniquely identifies each consumer, based on a user-ID and password system, or some other trusted secure mechanism

With this system 10, all user-specific information (such as preferences, subscriptions, purchasing information, etc), may be stored and managed by the Trust Authority, and may also potentially be stored in a secure local cache on the consumer's machine.

Preferably, The Trust Authority or Consumer Trust Envelope (through it's secured local cache) could then manage and verify all subscription, usage restrictions, purchasing extensions (for instance, credit card information and mailing address), and any other related Trust Relationship features or any other user-related features.

Content Updates

Preferably, the Trusted Publisher system 10 provides mechanisms for the Trusted Publishers to automatically, or through subscription system (see Purchasing Extensions and Usage Rights Management), or through manual interaction, cause updates of the content to be delivered to the consumer. This could include such things as: application or driver updates; documentation updates; news updates; media updates; or updates of any other type of content as defined above.

The consumer would have complete control over the acceptance and application of updates, and could screen them using the techniques described in the Content claims, Screening, and Content Violation section.

Communications

Preferably, the Trusted Publisher system 10 provides mechanisms for the Trusted Publishers to communicated directly or indirectly with their Consumers, while allowing the Consumers to have strict control over the timeliness and screening of such communications using the system described in the Content claims, Screening and Content Violation section above.

This mechanism could allow the Trusted Publisher to send arbitrary, trusted content to any of their consumers using the Publisher Trust Envelope and the Consumer Trust Envelope. This provides a direct communication channel between the Consumer and the Trusted Publisher for such things as: technical support; new content offers; content upgrade offers; marketing or related materials; news; forum materials; etc. The consumer has strict control over the content that could be delivered via this mechanism, and could completely disable this communication system altogether, or only for specific Trusted Publishers.

Trusted Publishing Example: Email

The following example illustrates the trusted publishing (30) and view of trusted content (40) workflows described above, using email as the communication medium. This is an example of trusted publishing, and is not meant as the sole representation of the technology, nor as a suggestion of any limitations for implementation.

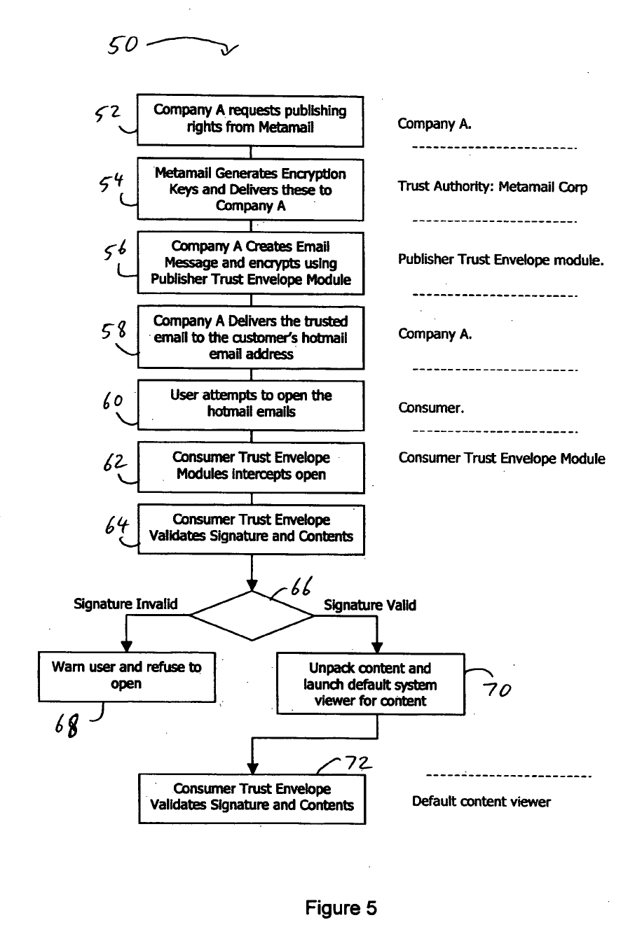

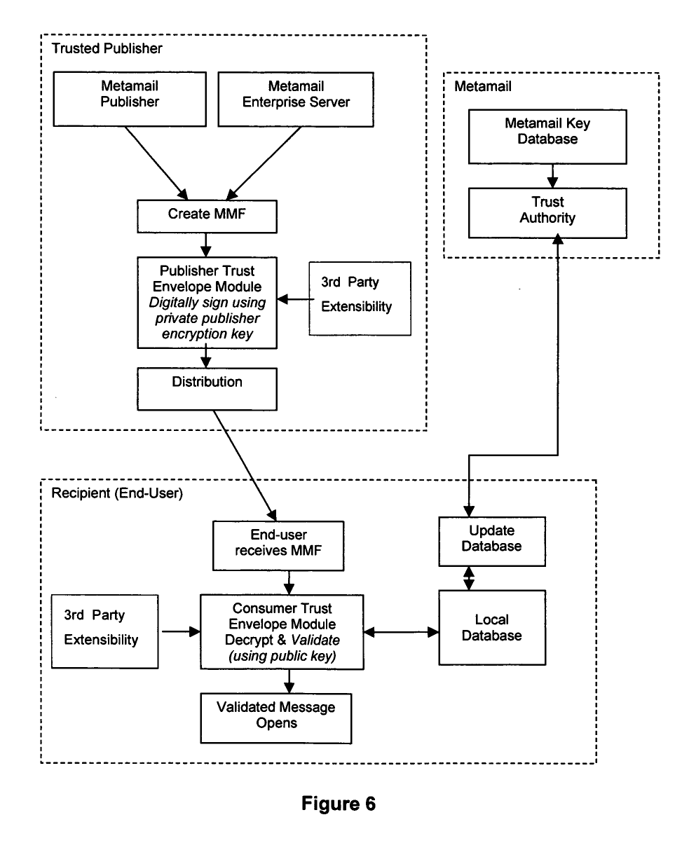

FIG. 5 shows in a flowchart an example of a method of publishing trusted content via email (50), in accordance with an embodiment of the trusted publishing system 10. The method steps are illustrated below:
A corporation, Company A, wishes to send a product offering to a customer via email. They negotiate a deal with a Trust Authority, in this case, say, Metamail Corporation. (52).
Metamail Corporation allocates a new pair of keys, a Publisher Encryption Key and a Consumer Decryption Key, and stores that pair of keys in a secured database, using a unique Publisher Identifier as the key. Metamail Corporation then securely delivers the Publisher Encryption Key to the Company A. (54).
Company A then composes the document having the email offer using the software of their choice, say, for instance, Metamail Publisher. Company A uses a plug-in to Metamail Publisher, which implements the Publisher Trust Envelope Module to hash the contents of the email message and signs the message using the Publisher Encryption Key, thus creating a trusted content email message. (56).
Company A then distributes the email offer to their customer. (58).
Consumer A receives the email from Company A using their Hotmail account.
Consumer A opens the email message within their hotmail environment. (60).
A Consumer Trust Envelope Module detects that the hotmail message has trusted content, and attempts to open the trusted content. (62).
The Consumer Trust Envelope Module extracts the Publisher Identifier from the trust envelope of the email message, and searches a database of Consumer Decryption Keys for the decryption key to use for this publisher. This database can be cached locally or provided online by the trust authority—the Consumer Trust Envelope Module will determine where to find the key. It then decrypts the hash, and performs the same hashing algorithm on the content as performed by the Publisher Trust Envelope Module. (64).
The Consumer Trust Envelope Module then compares the generated hash to the hash in the trust envelope (64). If they match (66), the email message is opened using the Metamail viewing module (70 and 72).
If they do not match (66), the user is informed that the message is not from a trusted publisher, and the email will not open (68).

FIG. 6 illustrates an example of the process of Publishing and Consuming trusted content, in accordance with an embodiment of the trusted publishing system 10. FIG. 6 also illustrates how Publisher Decryption Keys could be managed through via the Trust Authority and a locally cached database, to provide for offline validation of trusted content.

The trusted publishing system and methods according to the present invention may be implemented by any hardware, software or a combination of hardware and software having the above described functions. The software code, either in its entirety or a part thereof, may be stored in a computer readable memory. Further, a computer data signal representing the software code which may be embedded in a carrier wave may be transmitted via a communication network. Such a computer readable memory and a computer data signal are also within the scope of the present invention, as well as the hardware, software and the combination thereof.

While particular embodiments of the present invention have been shown and described, changes and modifications may be made to such embodiments without departing from the true scope of the invention.

1. A trusted publishing system for publishing trusted content, the system comprising:
a publisher trust envelope module for converting content into a trusted document; and
a consumer trust envelope module for validating the trusted document.

2. The system as claimed in claim 1, further comprising:
a trusted publisher module for generating the trusted document; and
a consumer module for viewing the trusted document.

3. The system as claimed in claim 2, further comprising a trusted authority module for managing a trust relationship between the trusted publisher module and the consumer module.

4. The system as claimed in claim 2, wherein the trusted publisher module includes:
a publisher encryption key for encrypting the content; and
the publisher trust envelope module.

5. The system as claimed in claim 2, wherein the consumer module includes:
one or more publisher decryption keys for decrypting the trusted document; and
the consumer trust envelope module.

6. The system as claimed in claim 1, wherein the publisher trust envelope module includes:
a hash unit for hashing the content into a hash;
an encryption unit for encrypting the hash;
a trust envelope generator for generating a trusted envelope housing the content, an encrypted hash of the content, and a publisher identifier; and
a repository for storing the trust envelope.

7. The system as claimed in claim 1, wherein the trusted document includes a trusted envelope having content, an encrypted hash of the content, and a publisher identifier.

8. The system as claimed in claim 7, wherein the trusted envelope further includes content type information for screening and filtering content, usage limitations, for use-based licensing agreements, billing information, and transactional information to manage relationships between the publisher trust envelope module and the consumer module.

9. A method of publishing trusted content, the method comprising the steps of:
generating a trust envelope for content;
placing an encrypted hash of the content in the trust envelope;
placing the content in the trust envelope; and
placing a publisher identifier in the trust envelope.

10. The method as claimed in claim 9, wherein the steps of generating a trust envelope includes the steps of
generating a hash of the content and encrypted content information; and
digitally signing the hash.

11. The method as claimed in claim 10, wherein the steps of generating a trust envelope further includes the steps of
requesting content tags which indicate the type of the content;
determining a content category from the type of the content;
receiving usage limitations codes, billing information codes, and transactional information codes of the content;
collecting as content information the type of the content, usage limitations codes, billing information codes, and transactional information codes of the content;
encrypting the content information and appending to the end of the content the encrypted content information.

12. The method as claimed in claim 11, further comprising the steps of
receiving and intercepting a content message;
obtaining from the content message a trust envelope having content, an encrypted hash of the content, and a publisher identifier;
determining a publisher classification of the sender of the content message;
determining a type of the content, usage limitations codes, billing information codes, and transactional information codes of the content based upon the publisher classification of the sender of the content message;
collecting as content information the type of the content, usage limitations codes, billing information codes, and transactional information codes of the content;
encrypting the content information and appending to the end of the content the encrypted content information.
determining a publisher decryption key to decrypt the encrypted hash of the content into a decrypted hash;
performing a local hash of the content and appended encrypted content information, and comparing the local hash with the decrypted hash; and
allowing a viewer to view the content if the local hash and the decrypted hash match.

13. A method of viewing trusted content, the method comprising the steps of:
receiving a trust envelope having content, an encrypted hash of the content, and a publisher identifier;
determining a publisher decryption key to decrypt the encrypted hash of the content into a decrypted hash;
performing a local hash of the content and comparing the local hash with the decrypted hash; and
allowing a viewer to view the content if the local hash and the decrypted hash match.

14. The method as claimed in claim 13, further comprising the steps of:
receiving and intercepting a content message; and
obtaining the trust envelope of the content message.

15. The method as claimed in claim 14, further comprising the steps of
determining a publisher classification of the sender of the content message;
determining a type of the content, usage limitations codes, billing information codes, and transactional information codes of the content based upon the publisher classification of the sender of the content message;
collecting as content information the type of the content, usage limitations codes, billing information codes, and transactional information codes of the content;
encrypting the content information and appending to the end of the content the encrypted content information.

16. The method as claimed in claim 15, wherein the step of performing a local hash is performed on the content having the encrypted content information appended.
